(19) United States
(12) Patent Application Publication
(10) Pub. No.: US 2020/0068520 A1
(43) Pub. Date: Feb. 27, 2020

(54) ENHANCEMENTS TO FINE TIMING MEASUREMENT (FTM) PROTOCOL

(71) Applicant: QUALCOMM Incorporated, San Diego, CA (US)

(72) Inventors: Subash Marri Sridhar, San Jose, CA (US); Sai Pradeep Venkatraman, Santa Clara, CA (US); Xiaoxin Zhang, Sunnyvale, CA (US)

(21) Appl. No.: 16/107,043

(22) Filed: Aug. 21, 2018

(51) Int. Cl. H04W 64/00; H04W 8/00; H04L 5/00; H04W 24/10; H04B 17/309; H04W 56/00

(52) U.S. Cl. CPC H04W 64/003; H04W 8/005; H04L 5/0055; H04W 84/12; H04B 17/309; H04W 56/004; H04W 24/10

(57) ABSTRACT

This disclosure provides systems, methods, and apparatus, including computer programs encoded on computer-readable media, for a ranging protocol between two wireless local area network (WLAN) devices. In one aspect, the ranging protocol may be adjusted based on channel quality of a wireless medium between the WLAN devices. For example, a quantity of ranging frames and bandwidth for the ranging frames may be adjusted based on the channel quality. In some implementations, the channel quality may be determined using setup messages for the ranging protocol without a wireless association between the WLAN devices. The ranging protocol may be useful for range determination in an indoor environment where a WLAN is deployed. In some implementations, the ranging protocol may be used to determine a location of a WLAN device.

### TECHNICAL FIELD

This disclosure relates to the field of wireless communication, and more particularly to time-of-flight positioning using wireless local area network (WLAN) communication.

### DESCRIPTION OF THE RELATED TECHNOLOGY

Traditional techniques for determining a location of a mobile device have relied on signals from satellite-based systems or wide area network (WAN) radio systems. For example, the traditional techniques may compare signal strength or timing associated with signals received from multiple satellite transmitters. These traditional techniques may be less effective in some environments, such as indoors or remote locations. More recent techniques may utilize timing measurements, also referred to as fine timing measurements (FTM) which can be used between two wireless local area network (WLAN) devices (which may be access points, APs, stations, STAs, or combination of an AP and a STA).

The FTM protocol (sometimes also referred to as Wi-Fi® Round-Trip-Time, or WiFi® RTT) describes a protocol for a first WLAN device to request a second WLAN device to transmit one or more FTM frames with timing information. The first WLAN device determines reception timestamps when it receives the FTM frames. The first WLAN device can determine a distance between the first WLAN device and the second WLAN device based on the timing information and the reception timestamps. Enhancements to the FTM protocol may improve yield and range capability.

### SUMMARY

The systems, methods, and devices of this disclosure each have several innovative aspects, no single one of which is solely responsible for the desirable attributes disclosed herein.

One innovative aspect of the subject matter described in this disclosure can be implemented as a method performed by a first wireless local area network (WLAN) device. The method may include sending an initial ranging protocol request message to initiate a ranging operation between the first WLAN device and a second WLAN device. The method may include determining a channel quality of a wireless medium between the first WLAN device and the second WLAN device. The method may include determining one or more parameters to be used for the ranging operation based, at least in part, on the channel quality. The one or more parameters may include at least one of a bandwidth setting for the ranging operation or a quantity of ranging frames to be transmitted by the second WLAN device. The method may include performing the ranging operation with the second WLAN device using the one or more parameters.

Another innovative aspect of the subject matter described in this disclosure can be implemented in a first WLAN device. In some implementations, the first WLAN device includes a processor and memory coupled with the processor. The memory may have instructions stored therein which, when executed by the processor, cause the first WLAN device to send an initial ranging protocol request message to initiate a ranging operation between the first WLAN device and a second WLAN device. The instructions, when executed by the processor, may cause the first WLAN device to determine a channel quality of a wireless medium between the first WLAN device and the second WLAN device. The instructions, when executed by the processor, may cause the first WLAN device to determine one or more parameters to be used for the ranging operation based, at least in part, on the channel quality. The one or more parameters may include at least one of a bandwidth setting for the ranging operation or a quantity of ranging frames to be transmitted by the second WLAN device. The instructions, when executed by the processor, may cause the first WLAN device to perform the ranging operation with the second WLAN device using the one or more parameters.

Another innovative aspect of the subject matter described in this disclosure can be implemented in a computer-readable medium having stored therein instructions which, when executed by a processor of a first WLAN device, causes the first WLAN device to send an initial ranging protocol request message to initiate a ranging operation between the first WLAN device and a second WLAN device. The instructions, when executed by the processor, may cause the first WLAN device to determine a channel quality of a wireless medium between the first WLAN device and the second WLAN device. The instructions, when executed by the processor, may cause the first WLAN device to determine one or more parameters to be used for the ranging operation based, at least in part, on the channel quality. The one or more parameters may include at least one of a bandwidth setting for the ranging operation or a quantity of ranging frames to be transmitted by the second WLAN device. The instructions, when executed by the processor, may cause the first WLAN device to perform the ranging operation with the second WLAN device using the one or more parameters.

In some implementations, the methods, first WLAN device and computer-readable media may be configured to send a subsequent ranging protocol request message to the second WLAN device before performing the ranging operation. The subsequent ranging protocol request message may indicate the one or more parameters to be used for the ranging operation.

In some implementations, the initial ranging protocol request message may include an initial parameter for the ranging operation. The subsequent ranging protocol request message may modify the initial parameter.

In some implementations, the methods, first WLAN device and computer-readable media may be configured to implement a fine timing measurement (FTM) protocol. The initial ranging protocol request message may be a first initial FTM request (iFTMR) message in accordance with the FTM protocol. The subsequent ranging protocol request message may be a second iFTMR message that includes a change to at least one parameter included in the first iFTMR message.

In some implementations, the first WLAN device may be an initiating station (STA) and the second WLAN device may be a responding STA in the FTM protocol.

In some implementations, the methods, first WLAN device and computer-readable media may be configured to receive a first response message from the second WLAN device in response to the initial ranging protocol request message. In some implementations, the methods, first WLAN device and computer-readable media may be configured to determine the channel quality based, at least in part, on the first response message.

In some implementations, the channel quality may be based on one or more of a received signal strength indicator (RSSI), a signal-to-noise ratio (SNR), a signal-to-interference-plus-noise ratio (SINR), or an error vector magnitude (EVM) associated with the first response message.

In some implementations, the first response message may include a first acknowledgement (ACK) message in response to the initial ranging protocol request message.

In some implementations, the methods, first WLAN device and computer-readable media may be configured to receive a channel quality metric from the second WLAN device, the channel quality metric associated with the initial ranging protocol request message.

In some implementations, the methods, first WLAN device and computer-readable media may be configured to include, in the initial ranging protocol request message, a plurality of alternative parameters supported by the first WLAN device for a corresponding plurality of channel quality thresholds. Determining the one or more parameters to be used for the ranging operation may include selecting the one or more parameters from the plurality of alternative parameters based on a comparison of the channel quality with the corresponding plurality of channel quality thresholds.

In some implementations, a first set of parameters may be used if the channel quality is less than a first threshold. A second set of parameters may be used if the channel quality is greater than the first threshold and less than a second threshold. A third set of parameters may be used if the channel quality is greater than the second threshold.

In some implementations, the one or more parameters may include a lower bandwidth setting or a higher quantity of ranging frames if the channel quality is less than a first threshold in comparison to a higher bandwidth setting or a lower quantity of ranging frames to be used if the channel quality is greater than the first threshold.

In some implementations, the methods, first WLAN device and computer-readable media may be configured to perform a ranging protocol negotiation between the first WLAN device and the second WLAN device based on the channel quality.

In some implementations, determining the one or more parameters causes the ranging operation to be adapted based on the channel quality determined without a full wireless association between the first WLAN device and the second WLAN device.

Another innovative aspect of the subject matter described in this disclosure can be implemented as a second WLAN device, as a method performed by the second WLAN device, or as computer-readable medium having instructions performed by a processor of a second WLAN device. The methods, second WLAN device and computer-readable media may be configured to receive an initial ranging protocol request message from a first WLAN device requesting a ranging operation between the first WLAN device and a second WLAN device. The methods, first WLAN device and computer-readable media may be configured to determine a channel quality of a wireless medium between the first WLAN device and the second WLAN device based, at least in part, on the initial ranging protocol request message. The methods, first WLAN device and computer-readable media may be configured to determine one or more parameters to be used for the ranging operation based, at least in part, on the channel quality, the one or more parameters including at least one of a bandwidth setting for the ranging operation or a quantity of ranging frames to be transmitted by the second WLAN device. The methods, first WLAN device and computer-readable media may be configured to cause transmission of a plurality of ranging frames from the second WLAN device to the first WLAN device in accordance with the one or more parameters.

In some implementations, the methods, second WLAN device and computer-readable media may be configured to transmit a first response message from the second WLAN device to the first WLAN device in response to the initial ranging protocol request message. The first response message may be useable by the first WLAN device to determine the channel quality of the wireless medium.

In some implementations, the first response message includes a channel quality metric indicating the channel quality determined by the second WLAN device.

In some implementations, the methods, second WLAN device and computer-readable media may be configured to receive, in the initial ranging protocol request message, a plurality of alternative parameters supported by the first WLAN device for a corresponding plurality of channel quality thresholds. Determining the one or more parameters to be used for the ranging operation may include selecting the one or more parameters from the plurality of alternative parameters based on a comparison of the channel quality with the corresponding plurality of channel quality thresholds.

In some implementations, the one or more parameters includes a lower bandwidth setting or a higher quantity of ranging frames if the channel quality is less than a first threshold in comparison to a higher bandwidth setting or a lower quantity of ranging frames to be used if the channel quality is greater than the first threshold.

In some implementations, the methods, second WLAN device and computer-readable media may be configured to perform a ranging protocol negotiation between the first WLAN device and the second WLAN device based on the channel quality, such that the ranging operation is adapted based on the channel quality without a full wireless association between the first WLAN device and the second WLAN device.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 depicts a system diagram of an example wireless local area network (WLAN) for introducing concepts of this disclosure.

FIG. 2 depicts another system diagram in which an example WLAN device may determine a location based on ranging operations with one or more other WLAN devices.

FIG. 3 depicts an example message flow diagram associated with a ranging protocol.

FIG. 4 shows a timing diagram illustrating an example process for a fine timing measurement (FTM) ranging protocol.

FIG. 5 shows an example variation of the FTM ranging protocol based on channel quality determined by an initiating station (STA).

FIG. 6 shows an example variation of the FTM ranging protocol based on channel quality determined by a responding STA.

FIG. 7 depicts a flowchart with example operations for selecting from among different ranging protocol parameters.

FIG. 8 depicts a conceptual diagram of an example message for use in a ranging protocol that implements aspects of this disclosure.

FIG. 9 depicts a flowchart with example operations for an Initiating STA implementing aspects of this disclosure.

FIG. 10 depicts a flowchart with example operations for a Responding STA implementing aspects of this disclosure.

FIG. 11 shows a block diagram of an example electronic device for implementing aspects of this disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The examples in this disclosure are based on wireless local area network (WLAN) communication according to the Institute of Electrical and Electronics Engineers (IEEE) 802.11 wireless standards. However, the described implementations may be implemented in any device, system or network that is capable of transmitting and receiving RF signals according to one or more of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G, 5G, 6G, or further implementations thereof, technology.

A wireless local area network (WLAN) in a home, apartment, business, or other area may include one or more WLAN devices. Traditional techniques for determining a location of a WLAN device have relied on satellite-based systems, which may be less effective indoors. More recent techniques for determining a location include ranging operations in which a ranging protocol is used to determine a distance between two WLAN devices. For example, a fine timing measurements (FTM) protocol describes messages and timing information exchanged between two WLAN devices which can determine a distance (range) based on timing calculations. The examples in this disclosure are based on the FTM protocol, as described in IEEE 802.11REVmc. However, the techniques may be applicable to other ranging protocols. In the FTM protocol, a first WLAN device (referred to as an Initiating STA) may send an initial ranging protocol request message (referred to as an initial FTM request (iFTMR) message) to a second WLAN device (referred to as a Responding STA). The Responding STA may send a first response message (also referred to as a first acknowledgement (ACK) message) to the Initiating STA. Following the first ACK message, the Responding STA will send a plurality of FTM frames to the Initiating STA. The Initiating STA may send acknowledgements (ACK) to each FTM frame. Each subsequent FTM frame includes timing information regarding a previous FTM frame and ACK exchange. For example, the timing information may indicate a time when the previous FTM frame was sent and when the previous ACK was received. Using the timing information from the Responding STA and the timing measured by the Initiating STA, the Initiating STA can determine a distance between the Initiating STA and the Responding STA. The Initiating STA can use this technique to determine distances to multiple Responding STAs. The distances may be used with location information regarding one or more Responding STAs to determine a location of the Initiating STA device relative to one or more Responding STAs.

Currently, the FTM protocol describes the transmission of a fixed number of FTM frames. Furthermore, the default bandwidth setting for the FTM frames is based on the widest bandwidth supported by the Initiating STA. For example, if the Initiating STA supports the use of an 80 MHz bandwidth for the FTM frames, the Initiating STA will inform the Responding STA know via the initial FTM Request that it supports 80 MHz bandwidth for the FTM frames. The Responding STA will check if an 80 MHz channel is available and start transmitting a fixed number of 80 MHz FTM frames. However, the use of a fixed number of FTM frames or the wide bandwidth channel may be undesirable. For example, if the channel quality between the two WLAN devices is poor (such as due to interference or low received signal strength), the Initiating STA may fail to properly receive the 80 MHz FTM frames. Failure to receive the FTM frames may result in a timeout counter or retransmission, which could delay the ranging operation. In systems in which the Responding STA changes the bandwidth for retransmitted FTM frames, there may be a delay or misalignment between the Initiating STA and the Responding STA. Currently, the FTM protocol has no mechanism to adjust the bandwidth setting or quantity of FTM frames to use for the ranging operation based on channel quality.

In accordance with this disclosure, the Initiating STA and Responding STA can determine the channel quality of the wireless medium before the FTM frames are transmitted. The bandwidth setting or the quantity of FTM frames can be adjusted based on the channel quality. By varying the bandwidth and quantity of FTM frames in response to the channel quality, the FTM protocol can increase the yield of successfully transmitted FTM frames and reduce latency associated with transmission failures or retries.

In one aspect of this disclosure, the FTM protocol can be used by two WLAN devices that do not have a full wireless association. As such, there may not be any traffic or communication regarding channel quality between the devices before the Initiating STA and Responding STA setup the ranging operation. The lack of prior communication may prevent the Initiating STA, such as a mobile device, and the Responding STA, such as an access point (AP), from establishing a common channel quality estimate prior to starting the FTM protocol session. In some implementations, the Initiating STA or the Responding STA may determine channel quality based on the initial ranging protocol request message or the first response message. Alternatively, or additionally, the FTM protocol may be modified to support communication regarding the channel quality before transmission of the FTM frames. In some implementations, the Initiating STA may include a set of parameters in the initial ranging protocol request message to indicate which bandwidth settings or quantity values may be used in relation to different channel quality thresholds.

In one aspect of this disclosure, the Initiating STA may send a first parameter (such as a default bandwidth setting or default quantity of FTM frames) in the initial ranging protocol request message. After receiving the first response message, the Initiating STA may determine the channel quality (based on the first response message) and send a subsequent ranging protocol request message to modify the first parameter. In some implementations, a deterministic algorithm may be used to determine the parameter (bandwidth setting or quantity) associated with the FTM frames. In some implementations, the Initiating STA and the Responding STA may use the same algorithm. For example, the Responding STA could determine a link quality based on the initial ranging protocol request message and modify the parameters using the deterministic algorithm. The Responding STA may include some parameters (or channel quality metric) in the first response message or may just use the new parameters when sending the FTM frames. If both the Initiating STA and Responding STA utilize the same algorithm, then they will arrive at the same parameters based on the link quality of the iFTMR and first ACK. The algorithm may be based on variables (such as thresholds and alternative parameters in relation to the thresholds) that can be shared between the Initiating STA and the Responding STA. For example, the thresholds may be negotiated or communicated between the Responding STA and Initiating STA as part of an FTM protocol setup phase.

Particular implementations of the subject matter described in this disclosure can be implemented to realize one or more of the following potential advantages. Using ranging protocol parameters that adapt based on the channel quality enables the ranging protocol to operate more efficiently in different wireless channel conditions. For example, when the channel quality is good, the Responding STA may transmit lower number of FTM frames at high bandwidth to achieve the greater accuracy, reduce ranging delays, and save power. Alternatively, when the channel quality is poor, the Responding STA may transmit a higher quantity of FTM frames at low bandwidth to improve yield, reduce retransmissions, and reduce ranging delays.

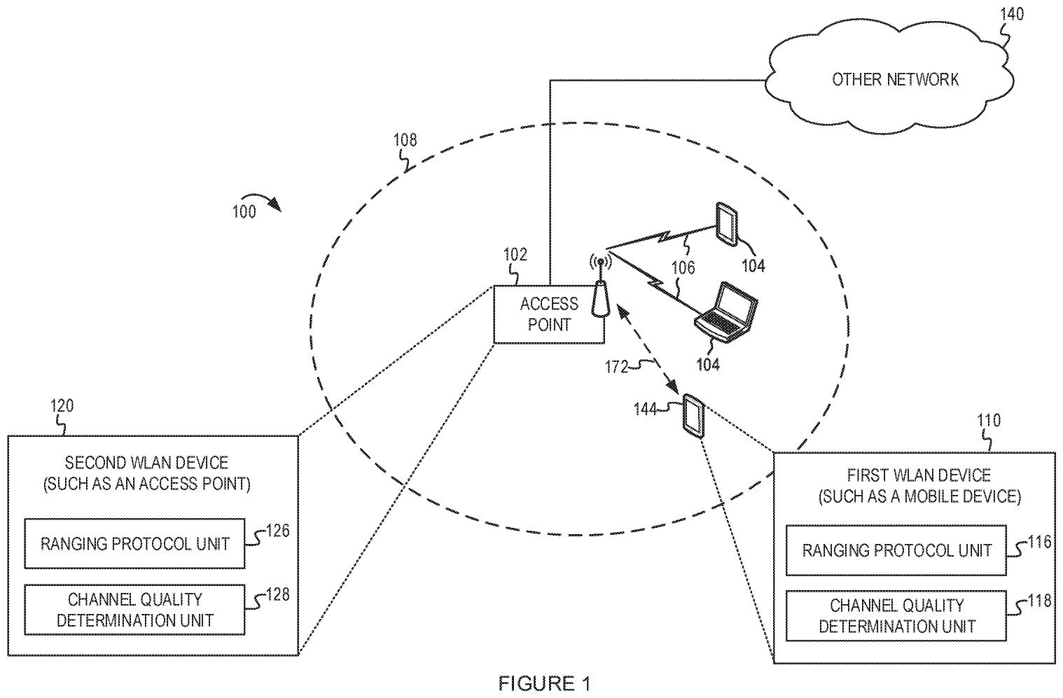

FIG. 1 depicts a system diagram of an example WLAN for introducing concepts of this disclosure. FIG. 1 includes a block diagram of an example wireless communication network 100. According to some aspects, the wireless communication network 100 can be an example of a WLAN such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof). The WLAN 100 may include numerous wireless communication devices such as an AP 102 and multiple STAs 104 having wireless associations with the AP 102. The IEEE 802.11-2016 specification defines a STA as an addressable unit. An AP is an entity that contains at least one STA and provides access via a wireless medium (WM) for associated STAs to access a distribution service (such as another network 140). Thus, an AP includes a STA and a distribution system access function (DSAF). In the example of FIG. 1, the AP 102 may be connected to a gateway device (not shown) which provides connectivity to the other network 140. The DSAF of the AP 102 may provide access between the STAs 104 and another network 140. While AP 102 is described as an access point using an infrastructure mode, in some implementations, the AP 102 may be a traditional STA which is operating as an AP. For example, the AP 102 may be a STA capable of operating in a peer-to-peer mode or independent mode. In some other examples, the AP 102 may be a software AP (SoftAP) operating on a computer system.

FIG. 1 also shows a first STA 144 which does not have a wireless association with the AP 102 but is within a communication range of the AP 102. Each of the STAs 104, 144 also may be referred to as a mobile station (MS), a mobile device, a mobile handset, a wireless handset, an access terminal (AT), a user equipment (UE), a subscriber station (SS), or a subscriber unit, among other possibilities. The STAs 104, 144 may represent various devices such as mobile phones, personal digital assistant (PDAs), other handheld devices, netbooks, notebook computers, tablet computers, laptops, display devices (for example, TVs, computer monitors, navigation systems, among others), wearable devices, music or other audio or stereo devices, remote control devices (“remotes”), printers, kitchen or other household appliances, key fobs (for example, for passive keyless entry and start (PKES) systems), among other possibilities.

The AP 102 and the associated STAs 104 may be referred to as a basic service set (BSS), which is managed by the AP 102. A BSS refers to one STA (such as an AP) that has established service settings and one or more STAs that have successfully synchronized the service settings. Alternatively, a BSS may describe a set of STAs have synchronized matching mesh service profiles. Using the example architecture in FIG. 1, the BSS may be identified by a service set identifier (SSID) that is advertised by the AP 102. The AP 102 may periodically broadcast beacon frames (“beacons”) to enable any STAs 104 within wireless range of the AP 102 to establish or maintain a respective communication link 106 (also referred to as a “Wi-Fi link” or “wireless association”) with the AP. An “unassociated STA” (such as the first STA 144) may not be considered part of the BSS because they do not have a wireless session established at the AP 102. The various STAs 104 in the WLAN may be able to communicate with external networks as well as with one another via the AP 102 and respective communication links 106. To establish a communication link 106 with an AP 102, each of the STAs is configured to perform passive or active scanning operations (“scans”) on frequency channels in one or more frequency bands (for example, the 2.4 GHz, 5 GHz, 6 GHz or 60 GHz bands). To perform passive scanning, a STA listens for beacons, which are transmitted by respective APs 102 at a periodic time interval referred to as the target beacon transmission time (TBTT) (measured in time units (TUs) where one TU is equal to 1024 microseconds (s)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link with the selected AP.

FIG. 1 additionally shows an example coverage area 108 of the AP 102, which may represent a basic service area (BSA) of the WLAN 100. While one AP 102 is shown in FIG. 1, the WLAN 100 can include multiple APs 102. As a result of the increasing ubiquity of wireless networks, a STA 104 may have the opportunity to select one of many BSSs within range of the STA 104 or select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP with which to associate. For example, a STA 104 that is moving relative to its associated AP 102 may perform a “roaming” scan to find another AP having more desirable network characteristics such as a greater received signal strength indicator (RSSI).

The APs 102 and STAs 104, 144 may function and communicate (via the respective communication links 106) according to the IEEE 802.11 family of standards (such as that defined by the IEEE 802.11-2016 specification or amendments thereof including, but not limited to, 802.11aa, 802.11ah, 802.11aq, 802.11ay, 802.11ax, 802.11az, and 802.11ba). These standards define the WLAN radio and baseband protocols for the physical (PHY) and medium access control (MAC) layers. The APs 102 and STAs 104, 144 transmit and receive frames (hereinafter also referred to as wireless communications”) to and from one another in the form of physical layer convergence protocol (PLCP) protocol data units (PPDUs). Each PPDU is a composite frame that includes a PLCP preamble and header as well as one or more MAC protocol data units (MPDUs).

The APs 102 and STAs 104, 144 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104, 144 described herein also may communicate in other frequency bands, such as the 6 GHz band, which may support both licensed and unlicensed communications. The APs 102 and STAs 104, 144 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11-extreme high throughput (EHT) standard amendments may be transmitted over the 2.4 and 5 GHz bands, each of which is divided into multiple 20 MHz channels. As such, these PPDUs are transmitted over a physical channel having a minimum bandwidth of 20 MHz. But larger channels can be formed through channel bonding. For example, PPDUs conforming to the IEEE 802.11n, 802.11ac, 802.11ax and 802.11-EHT standard amendments may be transmitted over physical channels having bandwidths of 40 MHz, 80 MHz or 160 MHz by bonding together two or more 20 MHz channels. Additionally, in some implementations, the AP 102 can transmit PPDUs to multiple STAs 104 simultaneously using one or both of multi-user (MU) multiple-input multiple-output (MIMO) (also known as spatial multiplexing) and orthogonal frequency division multiple access (OFDMA) schemes.

The first STA 144 may be an example of a first WLAN device 110. For brevity, the first WLAN device 110 also may be referred to as a first STA. Regardless of whether the first WLAN device 110 is an AP or a traditional STA, it may be referred to as a first STA in the ranging operation. The first WLAN device 110 also may include a ranging protocol unit 116 and a channel quality determination unit 118. The ranging protocol unit 116 may implement a ranging protocol, such as the FTM protocol. In some instances, the first WLAN device 110 may exchange service discovery frames with a second WLAN device 120 to ascertain whether both devices support ranging operations. The AP 102 may be an example of the second WLAN device 120. Regardless of whether the second WLAN device 120 is an AP or a traditional STA, it may be referred to as a second STA in the ranging operation. Either of the first STA or the second STA may be the Initiating STA or the Responding STA in the FTM ranging protocol. The second WLAN device 120 also may have a ranging protocol unit 126 for implementing the ranging protocol. The second WLAN device 120 also may have a channel quality determination unit 128 similar to the channel quality determination unit 118. As described further below, the channel quality determination unit 118 or the channel quality determination unit 128 (or both) may be used to determine the channel quality of the wireless medium between the first WLAN device 110 and the second WLAN device 120. The channel quality may be based on initial ranging protocol setup messages. The ranging protocol unit 116 or the ranging protocol unit 126 (or both) may use the channel quality to determine at least one parameter for the ranging protocol. For example, the parameter may be a bandwidth setting or quantity setting to be used for FTM frames.

The first and second WLAN devices 110, 120 may perform such ranging operations (“ranging”) during the discovery windows. The ranging may involve an exchange of FTM frames (such as those defined in IEEE 802.11REVmc). For example, a first WLAN device 110 may transmit unicast FTM requests to the second WLAN device 120. The second WLAN device 120 may then transmit a response to the first WLAN device 110. The first WLAN device 110 may then exchange several FTM frames with the second WLAN device 120. The first WLAN device 110 may determine a range 172 (also referred to as distance) between itself and the second WLAN device 120 based on the FTM frames. After determining the range 172, in some implementations, the first WLAN device 110 may transmit a range indication to the second WLAN device 120. For example, the range indication may include a distance value or an indication as to whether the second WLAN device 120 is within a service discovery threshold (for example, 3 meters (m), 5m, 10m, etc.) of the first WLAN device 110.

The ranging operation described in FIG. 1 involves a range between a first WLAN device and a second WLAN device. For example, the range 172 may be useful for determining the presence of the first STA 144 in relation to an AP 102. In some implementations, the ranging technique may be performed between a first WLAN device and multiple peer WLAN devices to determine a location of the WLAN device.

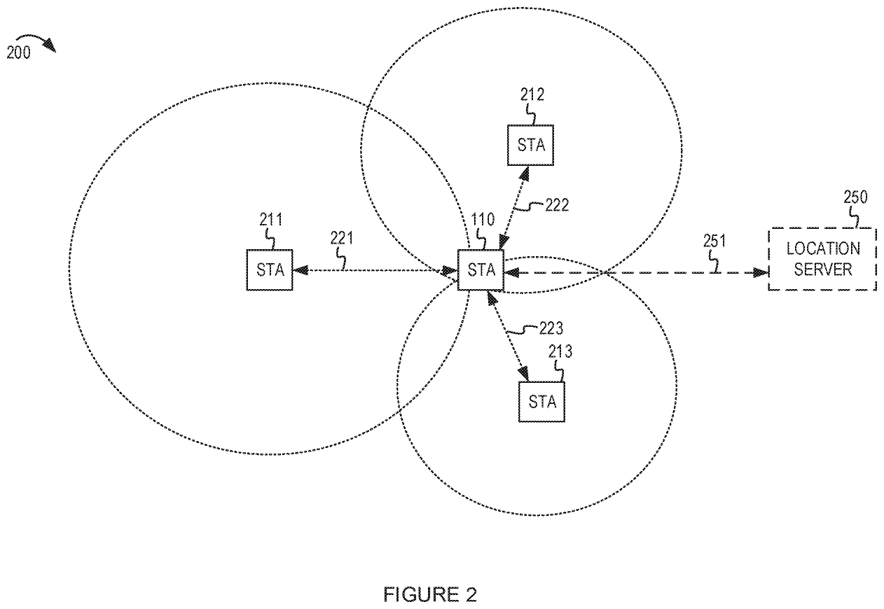

FIG. 2 depicts another system diagram in which an example WLAN device may determine a location based on ranging operations with one or more other WLAN devices. The system 200 shows the first WLAN device 110 (first STA) as well as multiple peer STAs 211, 212, 213. The first WLAN device 110 may be an AP or a traditional STA. The peer STAs 211, 212, 213 may be APs or traditional STAs. With three or more nearby STAs 211, 212, 213, it may be possible to determine a location of the first WLAN device 110 using trilateral calculation. For example, the first WLAN device 110 may determine the ranges 221, 222, 223 from it to the peer STAs 211, 212, 213, respectively. If the location of the peer STAs 211, 212, 213 are known, the first WLAN device 110 may determine its location based on the ranges 221, 222, 223 with good accuracy. In some implementations, the peer STAs 211, 212, 213 may report their location to the first WLAN device 110 as part of the FTM protocol or another management frame. For example, the peer STAs 211, 212, 213 may report Location Civic information, map coordinates, geographical address information, or the like. In some implementations, the first WLAN device 110 may obtain (shown as arrow 251) location information regarding the peer STAs 211, 212, 213 from a location server 250. For example, the location server 250 may maintain a database of locations associated with one or more access points. While three peer STAs 211, 212, 213 are shown in FIG. 2, other implementations may involve different numbers of STAs communicate with each other using a ranging protocol.

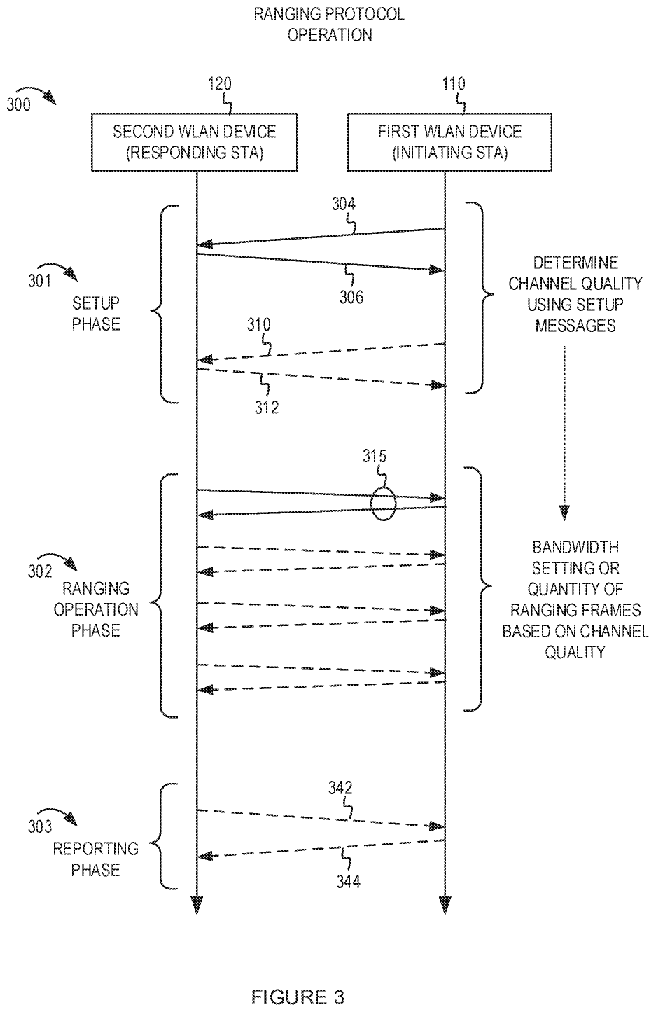

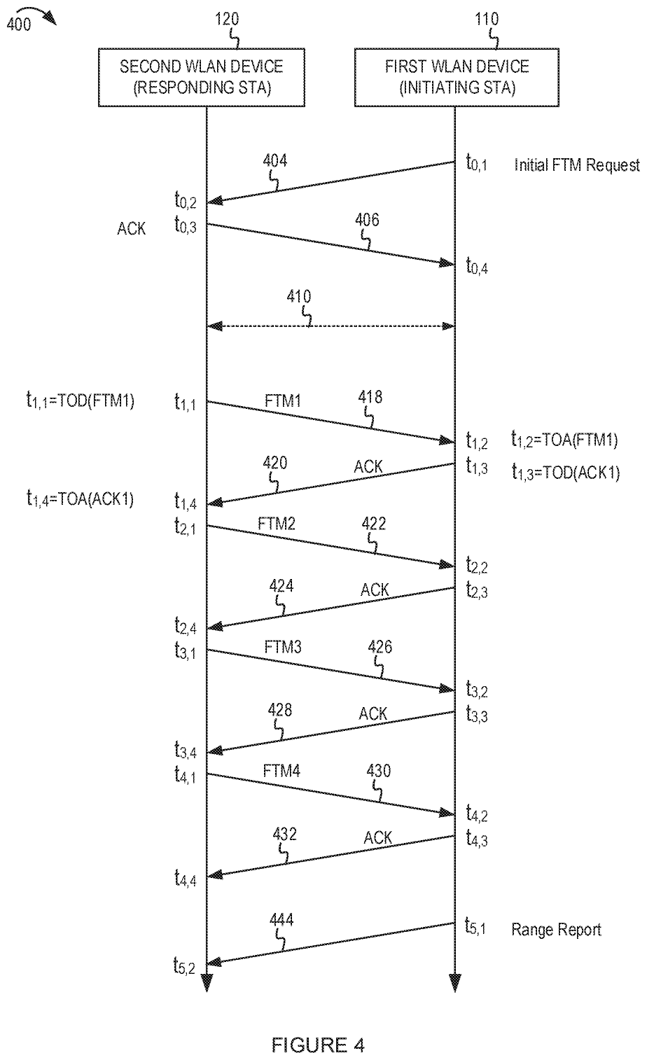

FIG. 3 depicts an example message flow diagram associated with a ranging protocol. The message flow diagram shows a first WLAN device 110 (as the Initiating STA) and the second WLAN device 120 (as the Responding STA) participating in an example ranging protocol 300 similar to the FTM protocol. The ranging protocol may include three phases: setup phase 301, a ranging operation phase 302, and a reporting phase 303. During the setup phase 301, the first WLAN device 110 and the second WLAN device 120 may initiate the ranging protocol session using setup messages. For example, the first WLAN device 110 may transmit an initial ranging protocol request message 304. The second WLAN device 120 may respond with a first response message 306 in response to the initial ranging protocol request message 304. For example, the first response message 306 may be a first ACK message. As described further in FIGS. 4-6, there may be additional messages in the setup phase 301. For example, the first WLAN device 110 may send a subsequent ranging protocol request message 310 to indicate one or more parameters to use for the operation phase 302. The one or more parameters may be based on the channel quality of the wireless media as determined by the first WLAN device 110 based on the received first response message 306. The second WLAN device 120 may transmit a subsequent ACK message 312. In another variation, the second WLAN device 120 may determine the channel quality of the wireless medium based on the initial ranging protocol request message 304. The first response message 306 may include an indication of the channel quality or may include parameters for the operation phase 302 as determined by the second WLAN device 120 based on the channel quality.

The operation phase 302 may include a plurality of FTM frames and ACK messages 315. The quantity of FTM frames may be based on the channel quality as determined by the first WLAN device 110 or the second WLAN device 120 (or both) during the setup phase 301. Furthermore, while the setup phase 301 may use a predetermined bandwidth (such as 20 MHz) for the setup messages, the operation phase 302 may use a different bandwidth (such as 40 MHz or 80 MHz). The bandwidth for the operation phase 302 may be determined by the first WLAN device 110 or the second WLAN device 120 (or both) based on the channel quality determined during the setup phase 301.

The reporting phase 303 may include reporting or polling messages. In some implementations, the reporting phase 303 may be eliminated from the ranging protocol. When included, the reporting phase 303 may include a range report message 344 from the first WLAN device 110 to the second WLAN device 120. The range report message 344 may be sent in response to a polling message 342 from the second WLAN device 120 to the first WLAN device 110.

FIG. 4 shows a timing diagram illustrating an example process for the FTM ranging protocol. As described above, the first WLAN device 110 and the second WLAN device 120 ranging operations using the FTM protocol. The ranging operation may involve an exchange of fine timing measurement FTM frames (such as those defined in the IEEE 802.11mc specification or revisions or updates thereof). FIG. 4 shows a timing diagram illustrating an example implementation of the FTM ranging protocol 400. The ranging protocol 400 may be conjunctively performed by the first WLAN device 110 and the second WLAN device 120, either or both of which may be an AP or a traditional STA.

The ranging protocol 400 begins with the first WLAN device 110 transmitting an initial FTM request message 404 at time t_{0,1}. Responsive to successfully receiving the initial ranging protocol request message 304 at time t_{0,2}, the second WLAN device 120 responds by transmitting a first ACK message 406 at time t_{0,3}, which the first WLAN device 110 receives at time t_{0,4}. In a traditional implementation of the FTM protocol, the first WLAN device 110 and the second WLAN device 120 would begin exchanging one or more FTM bursts using default FTM protocol parameters. However, as described above, the default FTM protocol parameters may be ineffective or inefficient due to wireless interference or other channel conditions affecting the wireless medium. In this disclosure, the FTM protocol may be modified based on a channel quality determination 410. FIGS. 3 and 5-6 describe examples of how the channel quality may be determined by the first WLAN device 110, the second WLAN device 120, or both. For example, the second WLAN device 120 may determine the channel quality based on the initial FTM request message 404. The first WLAN device 110 may determine the channel quality based on the first ACK message 406. Based on the channel quality determination 410, the first WLAN device 110 or the second WLAN device 120 (or both) may determine one or more parameters to use for the FTM frames. For example, the one or more parameters may define the quantity of FTM frames or the bandwidth (or both) to use for the transmission of FTM frames during the ranging operation phase.

During the ranging operation phase, the first WLAN device 110 and the second WLAN device 120 then exchange one or more FTM bursts, which may each include a number of exchanges of FTM action frames (herein referred to as “FTM frames”) and corresponding ACKs. In the example shown in FIG. 3, in a first exchange, beginning at time t_{1,1}, the second WLAN device 120 transmits a first FTM frame 418. The second WLAN device 120 records the time t_{1,1} as the time of departure (TOD) of the first FTM frame 418. The first WLAN device 110 receives the first FTM frame 418 at time t_{1,2} and transmits a first acknowledgment frame (ACK) 420 to the second WLAN device 120 at time t_{1,3}. The first WLAN device 110 records the time t_{1,2} as the time of arrival (TOA) of the first FTM frame 418, and the time t_{1,3} as the TOD of the first ACK 420. The second WLAN device 120 receives the first ACK 420 at time t_{1,4} and records the time t_{1,4} as the TOA of the first ACK 420.

Similarly, in a second exchange, beginning at time t_{2,1}, the second WLAN device 120 transmits a second FTM frame 422. The second FTM frame 422 includes a first field indicating the TOD of the first FTM frame 418 and a second field indicating the TOA of the first ACK 420. The first WLAN device 110 receives the second FTM frame 422 at time t_{2,2} and transmits a second ACK 424 to the second WLAN device 120 at time t_{2,3}. The second WLAN device 120 receives the second ACK 424 at time t_{2,4}. Similarly, in a third exchange, beginning at time t_{3,1}, the second WLAN device 120 transmits a third FTM frame 426. The third FTM frame 426 includes a first field indicating the TOD of the second FTM frame 422 and a second field indicating the TOA of the second ACK 424. The first WLAN device 110 receives the third FTM frame 426 at time t_{3,2} and transmits a third ACK 428 to the second WLAN device 120 at time t_{3,3}. The second WLAN device 120 receives the third ACK 428 at time t_{3,4}. Similarly, in a fourth exchange, beginning at time t_{4,1}, the second WLAN device 120 transmits a fourth FTM frame 430. The fourth FTM frame 430 includes a first field indicating the TOD of the third FTM frame 426 and a second field indicating the TOA of the third ACK 428. The first WLAN device 110 receives the fourth FTM frame 430 at time t_{4,2} and transmits a fourth ACK 432 to the second WLAN device 120 at time t_{4,3}. The second WLAN device 120 receives the fourth ACK 432 at time t_{4,4}.

The first WLAN device 110 determines a range indication based on the TODs and TOAs described above. For example, in implementations or instances in which an FTM burst includes four exchanges of FTM frames as described above, the first WLAN device 110 may be configured to determine a round trip time (RTT) between itself and the second WLAN device 120 based on Equation 1 below.

$$RTT = \frac{1}{N} [ ( {\sum }_{k = 1}^{N} {t}_{4 , k} - {\sum }_{k = 1}^{N} {t}_{1 , k} ) - ( {\sum }_{k = 1}^{N} {t}_{3 , k} - {\sum }_{k = 1}^{N} {t}_{2 , k} ) ] \qquad ( 1 )$$

where N is the number of FTM frames exchanged (4 in the example of FIG. 4).

In some implementations, the range indication is the RTT. Additionally or alternatively, in some implementations, the first WLAN device 110 may determine an actual approximate distance between itself and the second WLAN device 120, for example, by multiplying the RTT by an approximate speed of light in the wireless medium. In such instances, the range indication may additionally or alternatively include the distance value. Additionally or alternatively, the range indication may include an indication as to whether the second WLAN device 120 is within a proximity (for example, a service discovery threshold) of the first WLAN device 110 based on the RTT. In some implementations, the first WLAN device 110 may then transmit the range indication to the second WLAN device 120, for example, in a range report 444 at time t_{5,1}, which the second wireless device receives at time t_{5,2}.

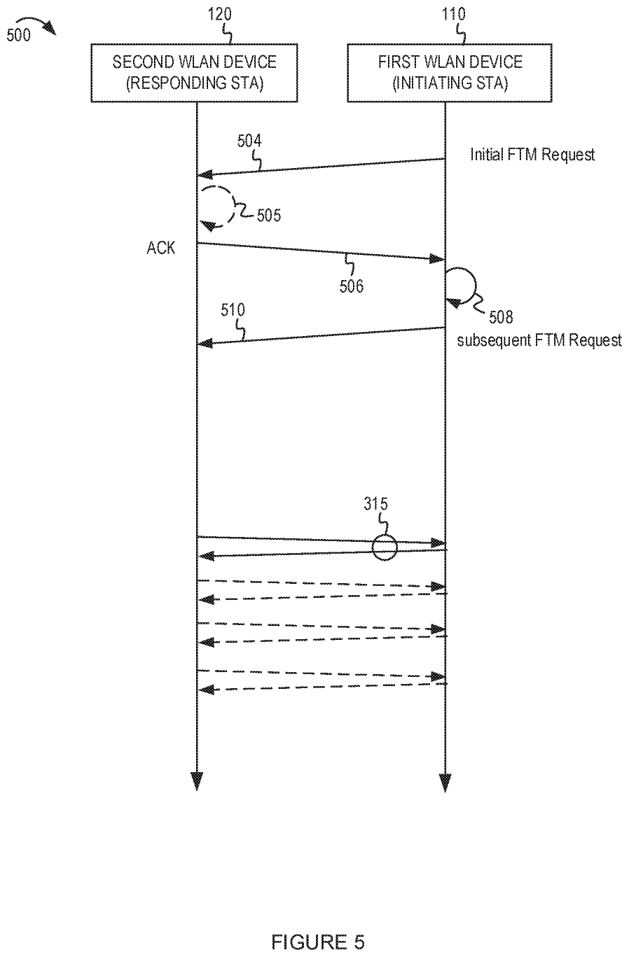

FIG. 5 shows an example variation of the FTM ranging protocol based on channel quality determined by an Initiating STA. FIG. 5 shows a timing diagram illustrating an implementation of an example ranging protocol 500 in which the Initiating STA (such as the first WLAN device 110) determines the channel quality for the example ranging protocol 500. The first WLAN device 110 sends an initial ranging protocol request message 504 to the second WLAN device 120. In response to the initial ranging protocol request message 504, the second WLAN device 120 sends a first response message 506. At process 508, the second WLAN device 120 may measure the channel quality of the wireless medium based on the first response message 506. For example, the channel quality may be based on one or more of a received signal strength indicator (RSSI), a signal-to-noise ratio (SNR), a signal-to-interference-plus-noise ratio (SINR), or an error vector magnitude (EVM) associated with the first response message 506. After process 508, the first WLAN device 110 may send a subsequent ranging protocol request message 510. The subsequent ranging protocol request message 510 may inform the second WLAN device 120 regarding parameters to use for the FTM frames. Following the subsequent ranging protocol request message 510, the second WLAN device 120 and the first WLAN device 110 may exchange a plurality of FTM frames and ACK messages 315. The quantity of FTM frames may be based on the channel quality as determined by the first WLAN device 110 at the process 508.

Other variations of the example ranging protocol 500 may be possible. For example, in some implementations, the initial ranging protocol request message 504 may include default parameters. The first WLAN device 110 may determine whether to send the subsequent ranging protocol request message 510 based on the channel quality determined at process 508. For example, the first WLAN device 110 may transmit the subsequent ranging protocol request message 510 if the process 508 determines that the channel quality warrants a change to the default parameters. The subsequent ranging protocol request message 510 may include a change to at least one parameter included the initial ranging protocol request message 504. If the channel quality is sufficient to support the default parameters in the initial ranging protocol request message 504, the first WLAN device 110 may refrain from sending the subsequent ranging protocol request message 510.

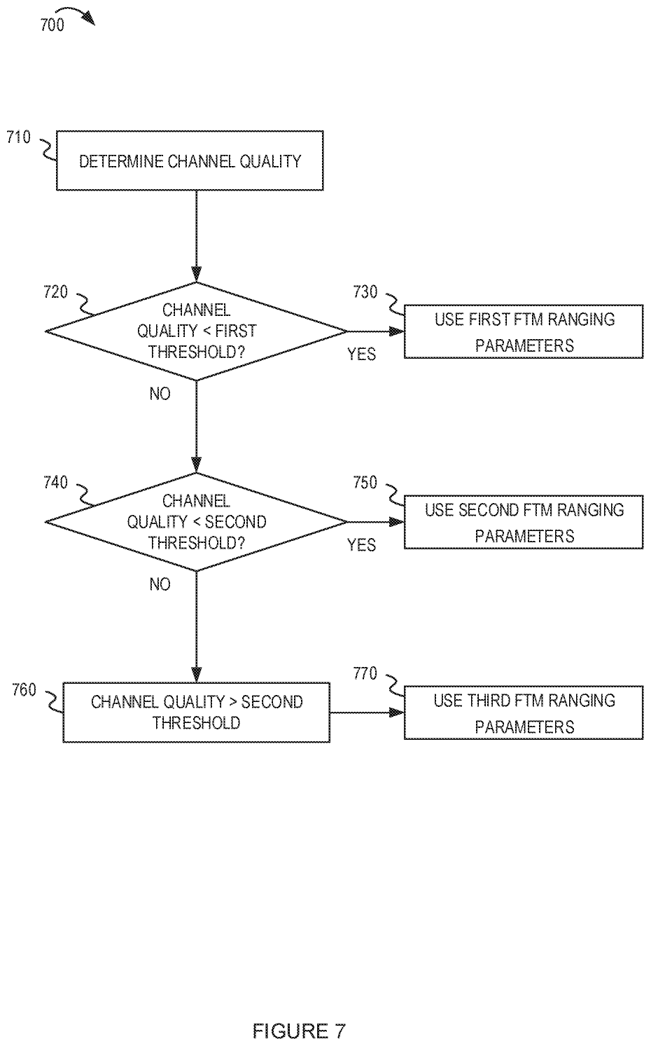

In another example variation, the second WLAN device 120 may assist in the determination of the channel quality. For example, at process 505, the second WLAN device 120 may determine a channel quality metric based on the initial ranging protocol request message 504. The second WLAN device 120 may include the channel quality metric in the first response message 506. Alternatively, the second WLAN device 120 may include one or more parameters in the first response message 506. For example, the second WLAN device 120 may include different parameters supported by the second WLAN device 120 and the thresholds used by the second WLAN device 120 for determining which parameters to select. Examples of the alternative parameters and thresholds associated with the alternative parameters are described in FIG. 7. At process 508, the first WLAN device 110 may select one or more parameters from those included in the first response message 506 and send an indication of the selected parameters in the subsequent ranging protocol request message 510.

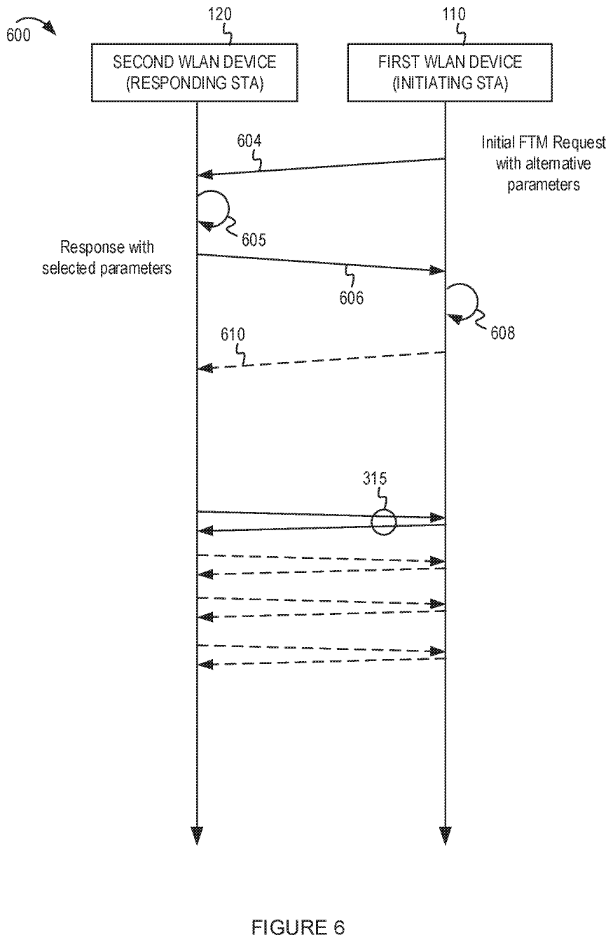

FIG. 6 shows an example variation of the FTM ranging protocol based on channel quality determined by a responding STA. The example ranging protocol 600 includes an initial ranging protocol request message 604 from the first WLAN device 110 to the second WLAN device 120. At process 605 the second WLAN device 120 may measure the channel quality based on the initial ranging protocol request message 604. The second WLAN device 120 may select one or more parameters based on the channel quality. The second WLAN device 120 may include an indication of the selected parameters in a first response message 606 to the first WLAN device 110. At process 608, the first WLAN device 110 may obtain the selected parameters from the first response message 606. In some implementations, the first WLAN device 110 may acknowledge the selected parameters in a subsequent ranging protocol request message 610. Following the setup messages, the second WLAN device 120 and the first WLAN device 110 may exchange a plurality of FTM frames and ACK messages 315. The quantity of FTM frames may be based on the channel quality as determined by the first WLAN device 110 at the process 605 (and process 608).

Other variations of the example ranging protocol 600 may be possible. For example, in some implementations, the first WLAN device 110 may include alternative parameters in the initial ranging protocol request message 604 and the thresholds associated with the alternative parameters. Examples of the alternative parameters and thresholds associated with the alternative parameters are described in FIG. 7. At process 605, the second WLAN device 120 may select one or more parameters from among the parameters in the initial ranging protocol request message 604. For example, the second WLAN device 120 may compare the determined channel quality with the thresholds to determine which set of parameters to use.

FIG. 7 depicts a flowchart with example operations for selecting from among different ranging protocol parameters. The flowchart 700 may be performed by a WLAN device (such as either the Initiating STA or the Responding STA, or both). The examples in FIG. 7 describe the use of thresholds in relation to channel quality to determine whether the channel quality is good or bad. For brevity, the descriptions of FIG. 7 are based on channel quality metrics (such as RSSI, SNR, and SINR), in which a high value indicates good channel quality and a low value indicates bad channel quality. For some other channel quality metrics (such as EVM), a low value indicates good channel quality and a high value indicates bad channel quality. In those cases, the comparison with the thresholds may be different. Furthermore, the flowchart 700 shows an implementation in which two thresholds may be used in relation to three different sets of alternative parameters. Other implementations may have different quantities of thresholds and corresponding sets of alternative parameters. The flowchart 700 begins at block 710. At block 710, the WLAN device may determine the channel quality. For example, the channel quality may be determined using the setup messages for the ranging protocol.

At decision 720, the WLAN device may determine whether the channel quality is less than a first threshold. For example, the WLAN device may compare a channel quality metric with a threshold value. Based on the decision 720, the WLAN device may determine that the channel quality is poor. If the channel quality is less than the first threshold, the flowchart 700 proceeds to block 730 in which the WLAN device may select a first set of FTM ranging parameters. For example, the first set of FTM ranging parameters may be used for robust transmission (greater quantity of FTM frames or lower bandwidth setting) compared to parameters that would be used for a wireless medium having a better channel quality.

At decision 720, if the channel quality is not less than the first threshold, the flowchart 700 proceeds to decision 740. At decision 740, the WLAN device may determine whether the channel quality is less than a second threshold. Thus, if the channel quality is greater than the first threshold (associated with a poor channel quality) and less than the second threshold, the WLAN device may determine that the channel quality is medium quality. If the channel quality is less than the second threshold, the flowchart 700 proceeds to block 750 in which the WLAN device may select a second set of FTM ranging parameters. For example, the second set of FTM ranging parameters may be used for a wireless medium having a medium channel quality.

At decision 740, if the channel quality is not less than the second threshold, the flowchart 700 proceeds to block 760. At block 760, the WLAN device may determine that the channel quality is greater than the second threshold. Thus, the WLAN device may determine that the channel quality is good quality. If the channel quality is greater than the second threshold, the flowchart 700 proceeds to block 770 in which the WLAN device may select a third set of FTM ranging parameters. For example, the third set of FTM ranging parameters may be used for a wireless medium having a good channel quality. The third set of FTM ranging parameters may use a lower quantity of FTM frames and a higher bandwidth.

The following example table shows how the parameters may be determined based on one type of channel quality metric (RSSI) in comparison with a first threshold (Th1) and a second threshold (Th2). The values in the following table are intended as illustrative examples only:

| | | | Good |
|---|---|---|---|
| | Poor channel | Medium channel | channel |
| | quality | quality | quality |
| Rule | RSSI < Th1 | Th1 < RSSI < Th2 | RSSI > Th2 |
| Parameter: Quantity of | 15 | 10 | 5 |
| FTM Frames in Burst | | | |
| Parameter: Bandwidth | 20 MHz | 40 MHz channel | 80 MHz |
| of channel for FTM | channel | | channel |
| frames | | | |

In some implementations, the initial ranging protocol request message may include a default set of parameters (such as those for a good quality channel). The WLAN device may revise the parameters based on a comparison of the determined channel quality with the threshold. As described above, in some implementations, the alternative parameters and thresholds may be included in a setup message for the ranging protocol so that both the Initiating STA and the Responding STA can use the same values and thresholds.

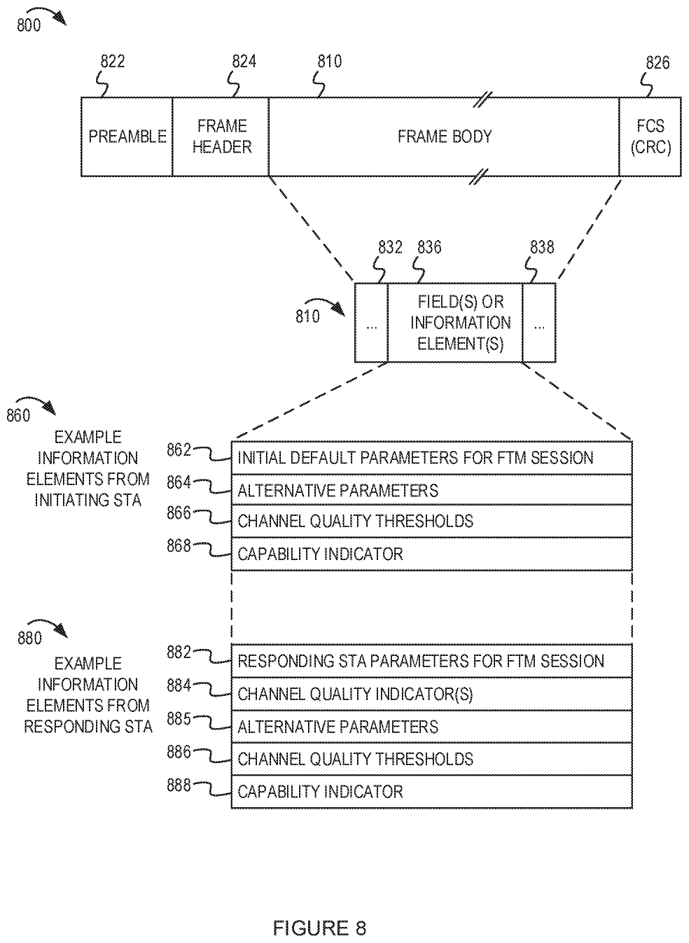

FIG. 8 depicts a conceptual diagram of an example message for use in a ranging protocol that implements aspects of this disclosure. For example, the example message 800 may be sent from a first WLAN device (as Initiating STA) to a second WLAN device (as Responding STA) or vice versa. The example message 800 may include a preamble 822, a header 824, a payload 810, and a frame check sequence (FCS) 826. The preamble 822 may include one or more bits to establish synchronization. The preamble 822 may be used, for example, when a dedicated discovery channel uses a listen-before-talk, contention-based access, or carrier sense access. In some implementations, if the dedicated discovery channel uses a scheduled timeslot for transmission, the preamble 822 may be omitted. The header 824 may include source and destination network addresses (such as the network address of the sending AP and receiving AP, respectively), the length of data frame, or other frame control information. In some implementations, the header 824 also may indicate a technology type associated with a technology-specific payload (if the payload 810 is specific to a particular technology type or types). The payload 810 may be used to convey the ranging protocol parameters. The ranging protocol parameters may be organized or formatted in a variety of ways. The payload 810 may be organized with a message format and may include information elements 832, 836, and 838. Several examples of information elements are illustrated in FIG. 8.

Example information elements 860 may be sent from an Initiating STA in a ranging protocol setup message. The example information elements 860 may include initial (default) parameters 862 for an FTM session. For example, the initial (default) parameters 862 may be included in an iFTMR. The initial (default) parameters 862 may be used if the channel quality supports them. The example information elements 860 may include alternative parameters 864 and channel quality thresholds 866 associated with the alternative parameters 864. In some implementations, the example information elements 860 may include a capability indicator 868 to indicate that the Initiating STA supports the features in this disclosure. For example, the capability indicator 868 may indicate support for a channel-adaptive ranging protocol.

Example information elements 880 may be sent from a Responding STA. The example information elements 880 may include Responding STA parameters 882 for an FTM session. For example, the Responding STA parameters 862 indicate which parameters are supported by or selected by the Responding STA based on the channel quality. In some implementations, the example information elements 880 may include channel quality indicators 884 (such as a channel quality metric measured by the Responding STA based on an initial ranging protocol request message). The example information elements 880 may include alternative parameters 885 and channel quality thresholds 886 associated with the alternative parameters 885. In some implementations, the example information elements 880 may include a capability indicator 888 to indicate that the Responding STA supports the features in this disclosure. For example, the capability indicator 888 may indicate support for a channel-adaptive ranging protocol.

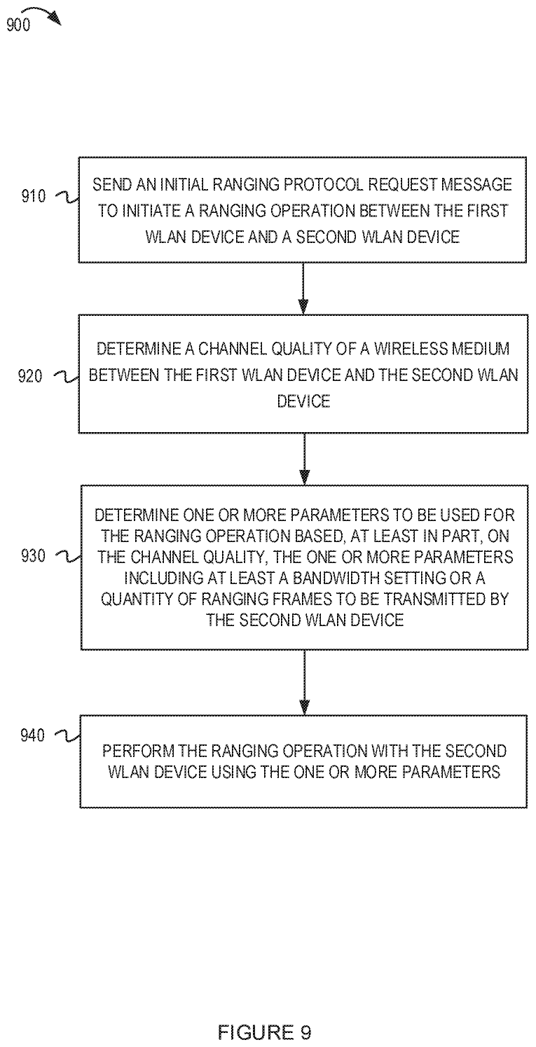

FIG. 9 depicts a flowchart with example operations for an initiating STA implementing aspects of this disclosure. The example operations may be performed by a first WLAN device (such as an Initiating STA). The flowchart 900 begins at block 910. At block 910, the first WLAN device may send an initial ranging protocol request message to initiate a ranging operation between the first WLAN device and a second WLAN device. For example, the initial ranging protocol request message may be similar to the iFTMR in the FTM protocol. In some implementations, the initial ranging protocol request message may include default parameters for the FTM protocol.

At block 920, the first WLAN device may determine a channel quality of a wireless medium between the first WLAN device and the second WLAN device. For example, the channel quality may be an RSSI, SINR, SNR, EVM, or the like. The channel quality may be determined based on a first response message from the second WLAN device.

At block 930, the first WLAN device may determine one or more parameters to be used for the ranging operation based on the channel quality. The one or more parameters may include at least a bandwidth setting or a quantity of ranging frames to be transmitted by the second WLAN device. For example, if the channel quality is poor, the first WLAN device may determine to request a greater quantity of FTM frames or a lower bandwidth setting.

At block 940, the first WLAN device may perform the ranging operation with the second WLAN device using the one or more parameters. For example, the first WLAN device may communicate the one or more parameters to the second WLAN device to cause the second WLAN device to send FTM frames in accordance with the determined parameters.

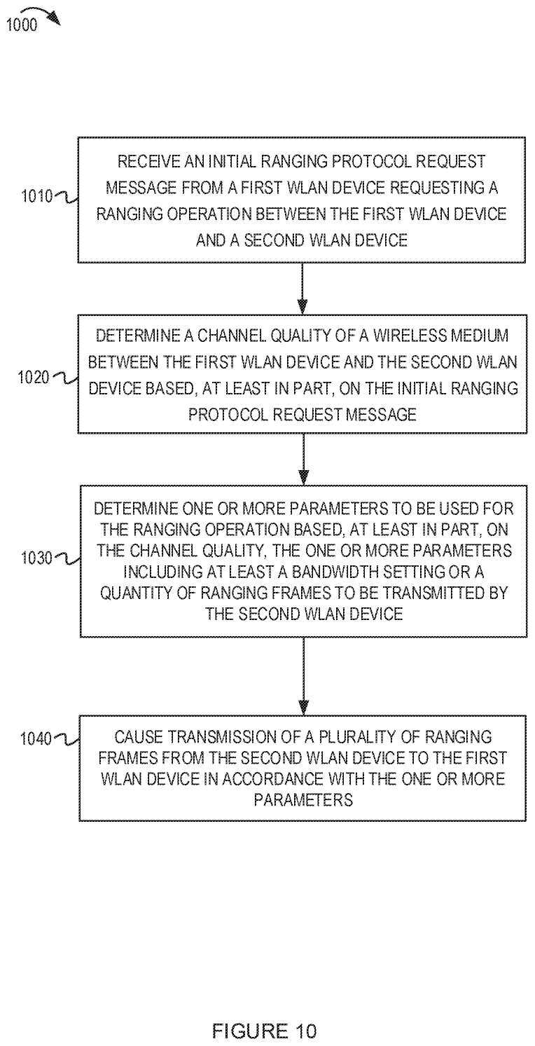

FIG. 10 depicts a flowchart with example operations for a responding STA implementing aspects of this disclosure. The example operations may be performed by a second WLAN device (such as a Responding STA) performing a ranging protocol operation with a first WLAN device. The flowchart 1000 begins at block 1010. At block 1010, the second WLAN device may receive an initial ranging protocol request message from a first WLAN device requesting a ranging operation between the first WLAN device and the second WLAN device.

At block 1020, the second WLAN device may determine a channel quality of a wireless medium between the first WLAN device and the second WLAN device based, at least in part, on the initial ranging protocol request message. For example, the second WLAN device may measure the RSSI, SINR, SNR, EVM, or the like, associated with the initial ranging protocol request message.

At block 1030, the second WLAN device may determine one or more parameters to be used for the ranging operation based, at least in part, on the channel quality. The one or more parameters may include at least a bandwidth setting or a quantity of ranging frames to be transmitted by the second WLAN device. In some implementations, the second WLAN device may communicate the selected parameters to the first WLAN device in a ranging protocol setup message in response to the initial ranging protocol request message.

At block 1040, the second WLAN device may cause transmission of a plurality of ranging frames from the second WLAN device to the first WLAN device in accordance with the one or more parameters. For example, the one or more parameters determined in block 1030 may include the quantity of ranging frames and channel bandwidth to use for the ranging frames.

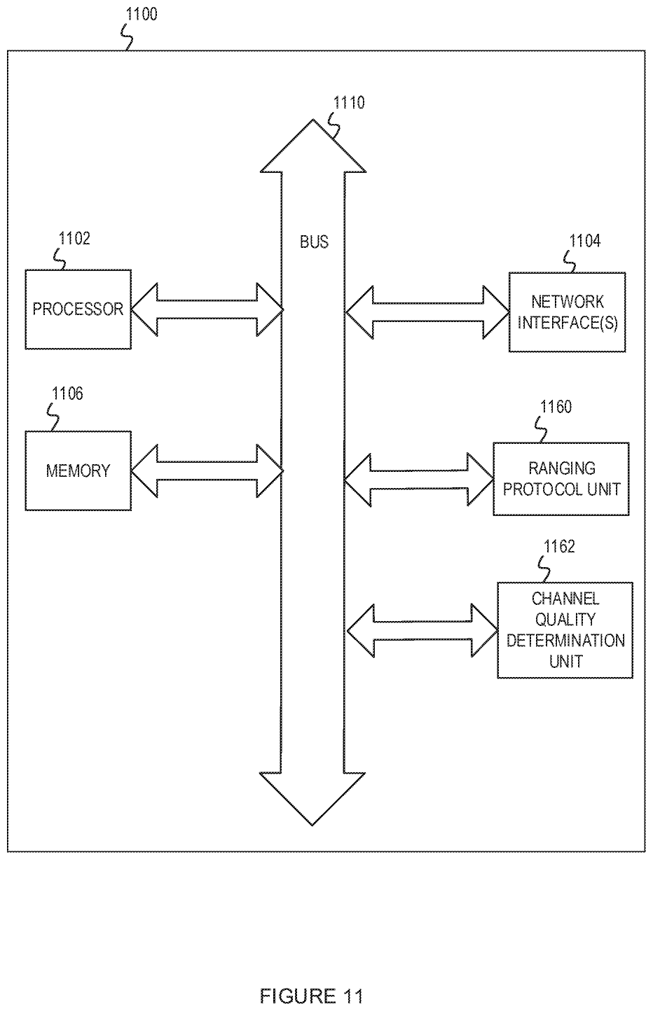

FIG. 11 shows a block diagram of an example electronic device for implementing aspects of this disclosure. In some implementations, the electronic device 1100 may be one of an access point (including any of the APs described herein), a range extender, or other electronic systems. The electronic device 1100 can include a processor 1102 (possibly including multiple processors, multiple cores, multiple nodes, or implementing multi-threading, etc.). The electronic device 1100 also can include a memory 1106. The memory 1106 may be system memory or any one or more of the possible realizations of computer-readable media described herein. The electronic device 1100 also can include a bus 1110 (such as PCI, ISA, PCI-Express, HyperTransport®, InfiniBand®, NuBus,® AHB, AXI, etc.), and a network interface 1104 that can include at least one of a wireless network interface (such as a WLAN interface, a Bluetooth® interface, a WiMAX® interface, a ZigBee® interface, a Wireless USB interface, etc.) and a wired network interface (such as an Ethernet interface, a powerline communication interface, etc.). In some implementations, the electronic device 1100 may support multiple network interfaces—each of which is configured to couple the electronic device 1100 to a different communication network.

The electronic device 1100 may include ranging protocol unit 1160 and a channel quality determination unit 1162. In some implementations, the ranging protocol unit 1160 and the channel quality determination unit 1162 may be distributed within the processor 1102, the memory 1106, and the bus 1110. The ranging protocol unit 1160 and the channel quality determination unit 1162 can perform some or all of the operations described herein. For example, the ranging protocol unit 1160 may be similar to the ranging protocol unit 126 or the ranging protocol unit 116 as described in FIG. 1. The ranging protocol unit 1160 may implement the ranging protocol with enhancements based on channel quality. The channel quality determination unit 1162 may be similar to the channel quality determination unit 128 or the channel quality determination unit 118 described in FIG. 1 and may determine the channel quality of the wireless medium between the electronic device 1100 and a peer WLAN device.

The memory 1106 can include computer instructions executable by the processor 1102 to implement the functionality of the implementations described in FIGS. 1-10. Any of these functionalities may be partially (or entirely) implemented in hardware or on the processor 1102. For example, the functionality may be implemented with an application specific integrated circuit, in logic implemented in the processor 1102, in a co-processor on a peripheral device or card, etc. Further, realizations may include fewer or additional components not illustrated in FIG. 11 (such as video cards, audio cards, additional network interfaces, peripheral devices, etc.). The processor 1102, the memory 1106, and the network interface 1104 are coupled to the bus 1110. Although illustrated as being coupled to the bus 1110, the memory 1106 may be coupled to the processor 1102.

FIGS. 1-11 and the operations described herein are examples meant to aid in understanding example implementations and should not be used to limit the potential implementations or limit the scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray™ disc where disks usually reproduce data magnetically, while discs reproduce data optically with lasers. Combinations also can be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method performed by a first wireless local area network (WLAN) device, comprising:
sending an initial ranging protocol request message to initiate a ranging operation between the first WLAN device and a second WLAN device;
determining a channel quality of a wireless medium between the first WLAN device and the second WLAN device;
determining one or more parameters to be used for the ranging operation based, at least in part, on the channel quality, the one or more parameters including at least one of a bandwidth setting for the ranging operation or a quantity of ranging frames to be transmitted by the second WLAN device; and
performing the ranging operation with the second WLAN device using the one or more parameters.

2. The method of claim 1, further comprising:
sending a subsequent ranging protocol request message to the second WLAN device before performing the ranging operation, the subsequent ranging protocol request message indicating the one or more parameters to be used for the ranging operation.

3. The method of claim 2,
wherein the initial ranging protocol request message includes an initial parameter for the ranging operation, and
wherein the subsequent ranging protocol request message modifies the initial parameter.

4. The method of claim 2, further comprising:
implementing a fine timing measurement (FTM) protocol,
wherein the initial ranging protocol request message is a first initial FTM request (iFTMR) message in accordance with the FTM protocol, and
wherein the subsequent ranging protocol request message is a second iFTMR message that includes a change to at least one parameter included in the first iFTMR message.

5. The method of claim 4, wherein the first WLAN device is an initiating station (STA) and the second WLAN device is a responding STA in the FTM protocol.

6. The method of claim 1, wherein determining the channel quality includes:
receiving a first response message from the second WLAN device in response to the initial ranging protocol request message; and
determining the channel quality based, at least in part, on the first response message.

7. The method of claim 6, wherein the channel quality is based on one or more of a received signal strength indicator (RSSI), a signal-to-noise ratio (SNR), a signal-to-interference-plus-noise ratio (SINR), or an error vector magnitude (EVM) associated with the first response message.

8. The method of claim 6, wherein the first response message includes a first acknowledgement (ACK) message in response to the initial ranging protocol request message.

9. The method of claim 1, wherein determining the channel quality includes receiving a channel quality metric from the second WLAN device, the channel quality metric associated with the initial ranging protocol request message.

10. The method of claim 1, further comprising:
including, in the initial ranging protocol request message, a plurality of alternative parameters supported by the first WLAN device for a corresponding plurality of channel quality thresholds, and
wherein determining the one or more parameters to be used for the ranging operation includes selecting the one or more parameters from the plurality of alternative parameters based on a comparison of the channel quality with the corresponding plurality of channel quality thresholds.

11. The method of claim 1,
wherein a first set of parameters is used if the channel quality is less than a first threshold,
wherein a second set of parameters is used if the channel quality is greater than the first threshold and less than a second threshold, and
wherein a third set of parameters is used if the channel quality is greater than the second threshold.

12. The method of claim 1, wherein the one or more parameters includes a lower bandwidth setting or a higher quantity of ranging frames if the channel quality is less than a first threshold in comparison to a higher bandwidth setting or a lower quantity of ranging frames to be used if the channel quality is greater than the first threshold.

13. The method of claim 1, wherein determining the one or more parameters to be used for the ranging operation includes performing a ranging protocol negotiation between the first WLAN device and the second WLAN device based on the channel quality.

14. The method of claim 1, wherein determining the one or more parameters causes the ranging operation to be adapted based on the channel quality determined without a full wireless association between the first WLAN device and the second WLAN device.

15. A method performed by a second wireless local area network (WLAN) device in accordance with a ranging protocol, comprising:
receiving an initial ranging protocol request message from a first WLAN device requesting a ranging operation between the first WLAN device and a second WLAN device;
determining a channel quality of a wireless medium between the first WLAN device and the second WLAN device based, at least in part, on the initial ranging protocol request message;
determining one or more parameters to be used for the ranging operation based, at least in part, on the channel quality, the one or more parameters including at least one of a bandwidth setting for the ranging operation or a quantity of ranging frames to be transmitted by the second WLAN device; and
causing transmission of a plurality of ranging frames from the second WLAN device to the first WLAN device in accordance with the one or more parameters.

16. The method of claim 15, further comprising transmitting a first response message from the second WLAN device to the first WLAN device in response to the initial ranging protocol request message, wherein the first response message is useable by the first WLAN device to determine the channel quality of the wireless medium.

17. The method of claim 16, wherein the first response message includes a channel quality metric indicating the channel quality determined by the second WLAN device.

18. The method of claim 15, further comprising:
receiving, in the initial ranging protocol request message, a plurality of alternative parameters supported by the first WLAN device for a corresponding plurality of channel quality thresholds, and
wherein determining the one or more parameters to be used for the ranging operation includes selecting the one or more parameters from the plurality of alternative parameters based on a comparison of the channel quality with the corresponding plurality of channel quality thresholds.

19. The method of claim 15, wherein the one or more parameters includes a lower bandwidth setting or a higher quantity of ranging frames if the channel quality is less than a first threshold in comparison to a higher bandwidth setting or a lower quantity of ranging frames to be used if the channel quality is greater than the first threshold.

20. The method of claim 15, wherein determining the one or more parameters to be used for the ranging operation includes performing a ranging protocol negotiation between the first WLAN device and the second WLAN device based on the channel quality, such that the ranging operation is adapted based on the channel quality without a full wireless association between the first WLAN device and the second WLAN device.

21. A first wireless local area network (WLAN) device, comprising:
a processor; and
memory coupled with the processor and having instructions stored therein which, when executed by the processor, cause the first WLAN device to:
send an initial ranging protocol request message to initiate a ranging operation between the first WLAN device and a second WLAN device;
determine a channel quality of a wireless medium between the first WLAN device and the second WLAN device;
determine one or more parameters to be used for the ranging operation based, at least in part, on the channel quality, the one or more parameters including at least one of a bandwidth setting for the ranging operation or a quantity of ranging frames to be transmitted by the second WLAN device; and
perform the ranging operation with the second WLAN device using the one or more parameters.

22. The first WLAN device of claim 21, wherein the instructions, when executed by the processor, cause the first WLAN device to:
send a subsequent ranging protocol request message to the second WLAN device before performing the ranging operation, the subsequent ranging protocol request message indicating the one or more parameters to be used for the ranging operation.

23. The first WLAN device of claim 22, wherein the initial ranging protocol request message includes an initial parameter for the ranging operation; and wherein the subsequent ranging protocol request message modifies the initial parameter.

24. The first WLAN device of claim 21, wherein the instructions to determine the channel quality includes instructions which, when executed by the processor, cause the first WLAN device to:
receive a first response message from the second WLAN device in response to the initial ranging protocol request message; and
determine the channel quality based, at least in part, on the first response message.

25. The first WLAN device of claim 21, wherein the instructions to determine the channel quality includes instructions which, when executed by the processor, cause the first WLAN device to receiving a channel quality metric from the second WLAN device, the channel quality metric associated with the initial ranging protocol request message.

26. The first WLAN device of claim 21, wherein the instructions, when executed by the processor, cause the first WLAN device to:
include, in the initial ranging protocol request message, a plurality of alternative parameters supported by the first WLAN device for a corresponding plurality of channel quality thresholds; and
select the one or more parameters from the plurality of alternative parameters based on a comparison of the channel quality with the corresponding plurality of channel quality thresholds.

27. A computer-readable medium having stored therein instructions which, when executed by a processor of a first wireless local area network (WLAN) device, causes the first WLAN device to:
send an initial ranging protocol request message to initiate a ranging operation between the first WLAN device and a second WLAN device;
determine a channel quality of a wireless medium between the first WLAN device and the second WLAN device;
determine one or more parameters to be used for the ranging operation based, at least in part, on the channel quality, the one or more parameters including at least one of a bandwidth setting for the ranging operation or a quantity of ranging frames to be transmitted by the second WLAN device; and
perform the ranging operation with the second WLAN device using the one or more parameters.

28. The computer-readable medium of claim 27, wherein the instructions, when executed by the processor, cause the first WLAN device to:
send a subsequent ranging protocol request message to the second WLAN device before performing the ranging operation, the subsequent ranging protocol request message indicating the one or more parameters to be used for the ranging operation.

29. The computer-readable medium of claim 28, wherein the initial ranging protocol request message includes an initial parameter for the ranging operation; and wherein the subsequent ranging protocol request message modifies the initial parameter.

30. The computer-readable medium of claim 27, wherein the instructions to determine the channel quality includes instructions which, when executed by the processor, cause the first WLAN device to:
receive a first response message from the second WLAN device in response to the initial ranging protocol request message; and
determine the channel quality based, at least in part, on the first response message.
